(19) United States
(12) Patent Application Publication
(10) Pub. No.: US 2020/0025550 A1
(43) Pub. Date: Jan. 23, 2020

(54) Angle-Measuring Assembly

(71) Applicants: Fabian Utermoehlen, Lippstadt (DE); Andreas Merz, Freiberg Am Neckar (DE)

(72) Inventors: Fabian Utermoehlen, Lippstadt (DE); Andreas Merz, Freiberg Am Neckar (DE)

(21) Appl. No.: 16/499,578

(22) PCT Filed: Apr. 27, 2018
(86) PCT No.: PCT/EP2018/060883

§ 371 Date: Sep. 30, 2019

(30) Foreign Application Priority Data
May 10, 2017 (DE) 10 2017 207 850.2

(51) Int. Cl. G01B 7/30; B60D 1/02; B60D 1/62; G01D 5/20

(52) U.S. Cl. CPC G01B 7/30; G01D 5/204; B60D 1/62; B60D 1/02

(57) ABSTRACT

The disclosure relates to an angle-measuring assembly for acquiring a pivot angle between a motor vehicle and a trailer coupled to the vehicle by a detachable coupling, wherein the coupling comprises a first coupling element connected to the tractor vehicle and a second coupling element connected to the trailer, having a measured value generator associated with the coupling for generating a magnetic field, having a measured value sensor associated with the coupling for acquiring the magnetic field, and having an analysis unit for determining the pivot angle in dependence on the magnetic field acquired by the measured value sensor. The measured value generator and the measured value sensor are both arranged on the first coupling element or the second coupling element. A magnetic field manipulator is arranged on the second or the first coupling element, opposite to the measured value generator and the measured value sensor.

The invention relates to an angle-measuring assembly for acquiring a pivot angle between the longitudinal center axis of a tractor vehicle and the longitudinal center axis of a trailer coupled to the tractor vehicle by a coupling, which is in particular detachable and forms a pivot axis in the vertex of the pivot angle, wherein the coupling comprises a first coupling element connected to the tractor vehicle and a second coupling element connected to the trailer, having a measured value generator associated with the coupling for generating a magnetic field, having a measured value sensor associated with the coupling for acquiring the magnetic field, and having an analysis unit for determining the pivot angle in dependence on the magnetic field acquired by the measured value sensor.

Furthermore, the invention relates to a coupling having such an angle-measuring assembly.

Moreover, the invention relates to a tractor-trailer assembly having a tractor vehicle and a trailer coupled to the tractor vehicle by a coupling, which is in particular detachable and forms a pivot axis in the vertex of the pivot angle, wherein the coupling comprises a first coupling element connected to the tractor vehicle and a second coupling element connected to the trailer.

Furthermore, the invention relates to a method for acquiring a pivot angle between the longitudinal center axis of a tractor vehicle and the longitudinal center axis of a trailer coupled to the tractor vehicle by a coupling, which is in particular detachable and forms a pivot axis in the vertex of the pivot angle, by means of an angle-measuring assembly.

### PRIOR ART

Angle measuring assemblies of the type mentioned at the outset are known from the prior art. Thus, published application DE 10 2014 224 808 A1, for example, discloses an angle-measuring assembly for acquiring a pivot angle between the longitudinal center axis of a tractor vehicle and the longitudinal center axis of a trailer. In such classical angle measuring assemblies, the acquisition of the pivot angle is carried out by means of a measured value sensor, which is configured for acquiring a measured value generator pivotable in relation to the measured value sensor, in particular in the form of a magnetic element. For this purpose, the measured value sensor is typically arranged on the tractor vehicle, in particular a first coupling element of the tractor vehicle, and the measured value generator is arranged on the trailer, in particular on a second coupling element of the trailer. Alternatively, the measured value sensor is arranged on the second coupling element and the measured value generator is arranged on the first coupling element. The measured value sensor and the measured value generator are typically integrated into the respective coupling element. It is disadvantageous in this case that such angle measuring assemblies are sensitive with respect to external magnetic fields. The acquisition of the pivot angle by means of such angle measuring assemblies is also strongly influenced by mechanical displacements between the measured value generator and the measured value sensor. A further disadvantage in this case is that such a measured value generator is costly.

### SUMMARY OF THE INVENTION

The angle-measuring assembly according to the invention having the features of claim 1 has the advantage that it is cost-effective in particular due to dispensing with a costly magnetic element. The usage of the measured value generator in the coupling element is also omitted. A further advantage is that the angle-measuring assembly is not susceptible to interference with respect to external magnetic fields. Moreover, the required installation space is small and the angle-measuring assembly is robust with respect to tolerances in regard to mechanical displacements and independent of many external influences, such as ambient humidity, temperature, and lubricant. It is provided for this purpose according to the invention that the measured value generator of the angle-measuring assembly as an emitter coil and the measured value sensor as a receiver coil are both arranged on the first coupling element or are both arranged on the second coupling element, and a magnetic field manipulator is arranged on the second or the first coupling element which is at least substantially axially opposite to the measured value generator and the measured value sensor in relation to the pivot axis.

The emitter coil and the receiver coil are designed as electromagnetic coils, are configured for generating and/or for acquiring magnetic fields, and are preferably arranged on the same component, in particular the same printed circuit board. The emitter coil is designed and configured for generating a magnetic field. The receiver coil is designed and configured for acquiring the magnetic field generated by the emitter coil. The emitter coil thus forms the measured value generator and the receiver coil forms the measured value sensor. Measured value generator and measured value sensor are both arranged on the first coupling element or are both arranged on the second coupling element and the magnetic field manipulator is arranged on the respective other, i.e., the second or the first coupling element. The magnetic field manipulator is at least substantially axially opposite to the measured value generator and/or the measured value sensor in relation to the pivot axis. The measured value generator, the measured value sensor, and the magnetic field manipulator are preferably arranged at the same radial distance to the pivot axis, but the magnetic field manipulator is arranged in a different axial position of the pivot axis than the measured value generator and the measured value sensor. The magnetic field manipulator are preferably located in a first imaginary plane, which extends perpendicularly to the pivot axis, and the measured value generator and the measured value sensor are located in a second imaginary plane, which also extends perpendicularly to the pivot axis. In this case, the magnetic field manipulator is mounted by means of the coupling so it is pivotable in relation to the measured value generator and/or the measured value sensor in such a way that it is always at least substantially located in the first imaginary plane. There is preferably at least one specific pivot angle at which the magnetic field manipulator, the measured value generator, and the measured value sensor are located on an imaginary line which is parallel to the pivot axis.

A magnetic field manipulator is to be understood here as an element or a structure which is configured to influence the magnetic field generated by the measured value generator in such a way that the pivot angle is ascertainable by means of the magnetic field acquired by the measured value sensor and an analysis unit. In this case, the magnetic field manipulator is preferably designed as a passive element, which is not dependent on any electrical voltage supply. In particular, the magnetic field manipulator has at least in a first region a first electrical and/or magnetic conductivity, which differs from a second electrical and/or magnetic conductivity in a second region of the magnetic field manipulator or a stationary region adjacent to the magnetic field manipulator.

The measured value generator and/or the measured value sensor are preferably formed on a curved and/or flexible component, in particular on a flexible printed circuit board.

According to one refinement of the invention, it is provided that the magnetic field manipulator is arranged or formed in or on a cylindrical element or section, in particular a pin, of the first coupling element. The cylindrical element is preferably a component of a pin-type coupling or open-end coupling, in which the second coupling element is substantially formed as an eye or comprises an eye, which is introduced for coupling into the first coupling element, in particular into an open-end opening of the open-end coupling, and is fixed therein by means of the cylindrical element of the first coupling element, preferably is penetrated, so that the second coupling element is pivotably mounted on the first coupling element. Such an arrangement or design of the magnetic field manipulator has the advantage that the angle-measuring assembly is implemented in a particularly space-saving and compact manner and can be formed or retrofitted in commercially available couplings, in particular pin-type couplings and open-end couplings.

Furthermore, it is preferably provided that the magnetic field manipulator is formed by one recess or multiple recesses in or on the first or the second coupling element. Such a magnetic field manipulator has the advantage that the angle-measuring assembly is cost-effective and can be formed without high technical expenditure in a simple manner, preferably by means of one or multiple milled grooves. Furthermore, such a magnetic field manipulator is not susceptible to interference and is not dependent on an electrical voltage supply.

According to an alternative embodiment of the invention, it is provided that the recess of the magnetic field manipulator is filled up using an electrically and/or magnetically insulating material, in particular an abrasion-resistant plastic and/or a ceramic. The coupling is thus formed particularly stably and is not susceptible to mechanical displacements. Alternatively, the recess is filled using a material which has a low electrical and/or magnetic conductivity. It is important that the electrical and/or magnetic conductivity of the recess or of the material differs from the electrical and/or magnetic conductivity of the surrounding material, i.e., in particular from the material of the first or the second coupling element. A microstructure is thus formed from various materials which influence the magnetic field generated by the emitter coil in dependence on the pivot angle in such a way that a pivot angle is ascertainable. The magnetic field manipulator, in particular the recess filled with air, in particular the electrically and/or magnetically insulating material, thus influences the magnetic field generated by the emitter coil more strongly or weakly than the regions surrounding the magnetic field manipulator. The magnetic field manipulator, in particular the material in the recess, is preferably nonmagnetic. The magnetic field manipulator particularly preferably does not comprise permanent magnets.

According to a further alternative embodiment of the invention, it is provided that the measured value generator and/or the measured value sensor extend(s) along a circumferential circle section in relation to the pivot axis. The circumferential circle section preferably comprises the entire circumferential circle, preferably at least a cohesive half of the circumferential circle, preferably at least an angle range relevant for the steering between traction vehicle and trailer. The accuracy of the angle-measuring assembly is thus enhanced.

According to one preferred refinement of the invention, it is provided that the circumferential circle section is a cylinder inner wall or a cylinder out wall of the first or second coupling element. The pivot axis preferably forms the center axis of the cylinder. Alternatively, the center axis of the cylinder is not located in the pivot axis, but rather parallel thereto at a distance. The cylinder is at least an imaginary cylinder which can be associated with the first or second coupling element, however, one of the two coupling elements is preferably formed at least in portions as a cylinder. In particular, provided by a cylinder as a pin of a pin-type coupling and/or an open-end coupling. A circumferential circle section of a second cylinder is preferably also associated with the magnetic field manipulator. These two cylinders are preferably arranged concentrically in relation to one another and have different radii. In this case, the magnetic field manipulator moves during a pivot on a circular path, which is at least substantially concentric in relation to the circumferential circle section, along which the measured value sensor and/or the measured value generator extends. An extremely accurate ascertainment, which is not susceptible to interference, of the pivot angle is thus provided.

According to one refinement of the invention, it is provided that the circumferential circle section is a sphere inner wall or a sphere outer wall of the first or second coupling element. The center point of such a sphere is preferably the vertex of the pivot angle. The magnetic field manipulator is preferably also arranged on a sphere inner surface or sphere outer surface of the first or second coupling element or at least can be associated therewith. Similarly to the description of the relative displacement of the two cylinders in relation to one another, the two spheres are also mounted so they are pivotable and/or rotatable in relation to one another and are arranged concentrically in relation to one another. By means of such an arrangement, not only pivot angles which are located in a road plane are ascertainable, but rather alternatively those pivot angles which are located in a plane which is perpendicular or at an angle to the road plane.

According to one refinement of the invention, it is provided that the measured value generator and/or the measured value sensor are protected, in particular are covered, by means of a protective layer. The protective layer is preferably electrically insulating and advantageously prevents an abrasion of the measured value generator and/or the measured value sensor.

According to an alternative embodiment of the invention, it is provided that the measured value generator and the measured value sensor are arranged on the coupling in such a way that the measured value sensor can be inductively coupled to the measured value generator. In particular, the measured value generator is inductively coupled to the measured value sensor if a coupling exists and/or the coupling acts between tractor vehicle and trailer and an electrical voltage is applied to the measured value generator and/or to the measured value sensor. In particular, the measured value sensor is thus arranged in an active region of a magnetic field which can be generated by the measured value generator.

The coupling according to the invention having the features of claim 10 provides that the coupling is provided having an angle-measuring assembly, wherein the angle-measuring assembly is designed according to the invention. Such a coupling is producible particularly cost-effectively and is not susceptible to interference with respect to mechanical displacements, temperature changes, ambient humidity changes, and/or external electromagnetic fields. Moreover, the above-mentioned advantages result.

According to one refinement of the invention, it is provided that the coupling is designed as a ball-hitch coupling, fifth-wheel coupling, pin-type coupling, and/or fifth-wheel coupling. Such couplings are extremely stable, widespread, and thus usable in a variety of ways.

The tractor-trailer assembly according to the invention having the features of claim 12 provides that the coupling is designed according to the invention. Such a tractor-trailer assembly is particularly safe when driving in traffic because of the coupling which is not susceptible to interference.

The method according to the invention having the features of claim 13 provides the following steps: generating a magnetic field by means of the measured value generator, acquiring the magnetic field by means of the magnetic field sensor, and determining the pivot angle by means of the analysis unit in dependence on the acquired magnetic field influenced by the magnetic field manipulator. With the aid of such a method, the acquisition of a pivot angle can be carried out particularly cost-effectively and substantially undisturbed by temperature, ambient humidity, lubricants, and/or mechanical displacements between the coupling elements.

The invention is explained in greater detail hereafter on the basis of the drawings. In the figures:

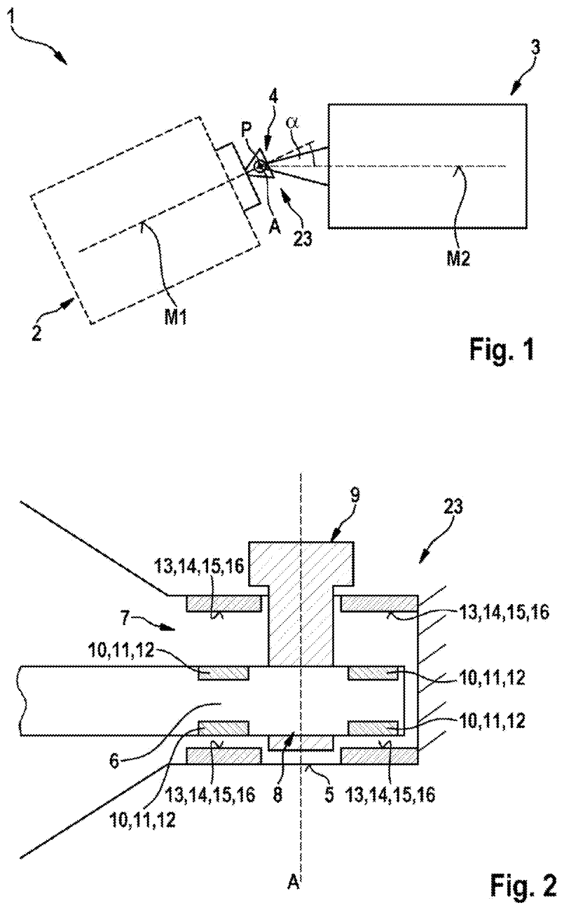

FIG. 1 shows a tractor-trailer assembly having an open-end coupling and an angle-measuring assembly in a top view according to a first exemplary embodiment,

FIG. 2 shows an open-end coupling having an angle-measuring assembly in a side view,

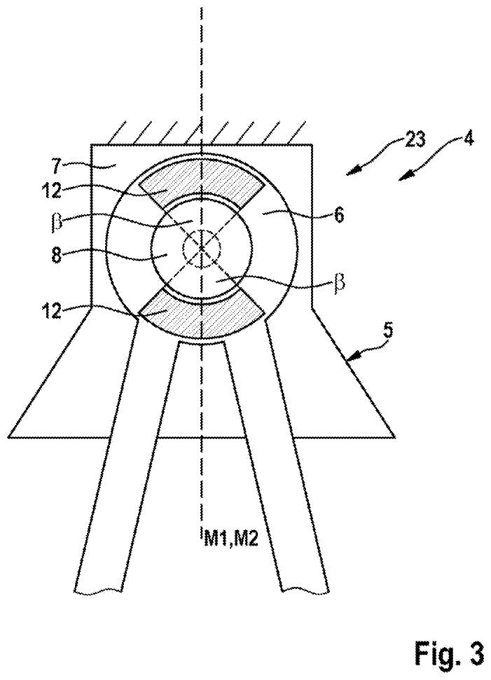

FIG. 3 shows a coupling having an angle-measuring assembly in a top view, and

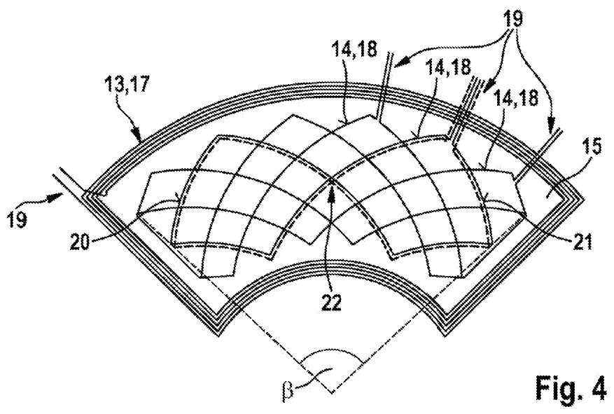

FIG. 4 shows an emitter coil and multiple receiver coils on a printed circuit board.

FIG. 1 shows a simplified view of a tractor-trailer assembly 1 having a tractor vehicle 2 and a trailer 3, wherein the tractor vehicle 2 is coupled to the trailer 3 in the vertex P of the pivot angle α by means of a coupling 4 and thus a pivot angle A is formed. In FIG. 1, the pivot axis A is perpendicular to the plane of the drawing and extends through the vertex P. The pivot angle α does not necessarily have to be located in the illustrated plane of the drawing, but rather can also be located in a plane perpendicular or at an angle thereto. In particular in the event of a movement of the tractor vehicle 2 and the trailer 3 along an increasing or decreasing slope, for example, on a hillside, the pivot angle α also has a component which is perpendicular to the plane of the drawing. It is important, as is recognizable in FIG. 1, that the pivot angle α is located between the longitudinal center axis M1 of the tractor vehicle 2 and the longitudinal center axis M2 of the trailer 3. In the case illustrated here of an open-end coupling, however, the pivot angle is preferably ascertained which is located in the plane of the drawing of FIG. 1, i.e., a parallel plane in relation to the road plane. At least the portion of the pivot angle which is located in the plane of the drawing of FIG. 1 is particularly preferably ascertained.

FIG. 2 shows the coupling 4 between the first coupling element 5 connected to the tractor vehicle and the second coupling element 6 connected to the trailer 3. In this exemplary embodiment, the first coupling element is substantially formed as an open-end receptacle 7. The second coupling element is formed here as an eye 8 on the front end—in the direction of the tractor vehicle 2—of a drawbar. For coupling, the eye 8 is introduced into the open-end opening 7 and penetrated using a pin 9, so that the first coupling element 5 is coupled to the second coupling element 6.

Moreover, four magnetic field manipulators 10 are shown in FIG. 2, wherein each magnetic field manipulator 10 is formed here as a recess 11, in particular as a milled groove 12. The construction and the arrangement of all magnetic field manipulators 10 are described hereafter on the basis of one magnetic field manipulator 10. The measured value generator 13 associated with the magnetic field manipulator 10 and the measured value sensor 14 associated with the magnetic field manipulator 10, which acquire the pivot angle α in cooperation with the recess 11, are each formed on a printed circuit board 15, a flexible printed circuit board here.

The printed circuit board 15 is arranged in a circumferential direction around the pivot axis A in the receptacle 7 on the first coupling element 5. The surface of the printed circuit board 15 is arranged at a distance to the pivot axis A and in a perpendicular plane in relation to the pivot axis A. In this perpendicular plane, the printed circuit board 15 is arranged in a curve along a circumferential circle section around the pivot axis A—as is apparent from FIG. 3. The printed circuit board 15 thus has the form of a ring section having a ring width which is nonzero.

The milled groove 12 respectively axially opposite to the printed circuit board 15 is also preferably formed ring-shaped in this exemplary embodiment. Alternatively, however, it can be rectangular or can also have other shapes. It is important that the magnetic field influenced thereby is influenced in such a manner that the pivot angle α is ascertainable by means of the induced voltage in a receiver coil. One printed circuit board 15 is preferably associated with each magnetic field manipulator 10. The four magnetic field manipulators 10 shown in FIG. 2 are thus associated with a total of four circuit boards 15.

In a further exemplary embodiment (not shown here), the milled groove 12 is at least partially filled up using an electrically and/or magnetically nonconductive material, in particular an abrasion-resistant plastic or a ceramic. Alternatively, multiple milled grooves 12 are provided, wherein each of the milled grooves 12 is filled up using a material which is not electrically or magnetically conductive or is only slightly conductive to enhance the stability of the coupling 4 or to achieve a desired electromagnetic interference behavior of the magnetic field manipulator 10.

FIG. 3 shows the coupling 4 in a top view. It can be seen well here that the printed circuit board 15 is arranged along a circumferential circle section and forms a ring section having recognizable width in relation to the pivot axis A. The printed circuit board 15 (not recognizable here) is preferably arranged substantially symmetrically in relation to the longitudinal center axis M2 of the trailer. Accordingly, the milled groove 12 is arranged substantially symmetrically in relation to the longitudinal center axis M1 of the tractor vehicle 2. Since the two longitudinal center axes M1, M2 are coincident with one another in FIG. 3, the pivot angle is zero here and is thus not shown.

In FIG. 3, the receiver coil arranged on the printed circuit board 15 and preferably also the milled groove 12 extend along the circumferential circle section in relation to the pivot axis A over an aperture angle β of approximately 90°. Alternatively, however, the milled groove 12 and the printed circuit board 15 extend over a larger or smaller circumferential circle section. Alternatively, the milled groove 12 and the printed circuit board 15 extend over the entire circumferential circle, so that they enclose the eye 8. The aperture angle β over which the printed circuit board 15, in particular the receiver coil located thereon, extends, is at least twice the maximum pivot angle α to be acquired.

Furthermore, FIG. 2 shows that a protective layer 16 is arranged on the printed circuit board 15, in particular between the printed circuit board 15 and the second coupling element 6. The protective layer 16 protects the printed circuit board 15 from mechanical abrasion and/or is electrically conductive.

FIG. 4 shows the measured value generator 13 as an outer emitter coil 17 and the measured value sensor 14, which is formed by three receiver coils 18 arranged inside the emitter coil 17. All emitter and receiver coils 17, 18 are arranged on a common carrier, namely the printed circuit board 15, which is designed in particular as a flexible printed circuit board. Each of the coils 17, 18 can comprise one or, as shown on the basis of the emitter coil 17, multiple conductor loops. For the sake of comprehensibility, only one conductor loop is shown here for each of the receiver coils 18, however. For further improvement of the comprehensibility, one of the receiver coils 18 is emphasized by dashed lines.

In the case illustrated here, one of the coils 17, 18, in particular the emitter coil 17, is an outer coil, and the respective other coil, in particular the receiver coil 18, is an inner coil. Observed in a cross-sectional plane—perpendicular in relation to an axial direction of the coil—the at least one conductor loop of the outer coil substantially encloses a first area, in which the at least one conductor loop of the inner coil is arranged. The second area enclosed by the inner coil is parallel to the first area; it is preferably located in the first area.

In particular, the conductor track of the emitter coil 17 in FIG. 4 extends along a first outer contour of a circular ring segment and thus forms a conductor loop. Each of the conductor tracks of the receiver coils 18 extends inside the first circular ring segment and is formed from circular conductor track sections. Alternatively, the conductor track sections are formed sinusoidal. At each point at which the receiver coils 18 touch an imaginary second outer contour of an imaginary circular ring segment, which is located inside and preferably concentrically in relation to the first circular ring segment, the receiver coil makes a bend analogous to the laws of reflection of geometrical optics, so that the two angles between conductor track of the receiver coil 18 and the second outer contour are equal in absolute value on both sides of the bend. The sinusoidal shape of a received electrical voltage signal is thus ensured in the receiver coil 18.

An electrical AC voltage having a frequency of preferably several megahertz, particularly preferably 5 MHz, is applied to the emitter coil 17 by means of the contact region 19, specifically in such a way that an electromagnetic alternating field forms substantially perpendicularly in relation to the area enclosed by the conductor loop, i.e., perpendicular to the plane of the drawing here, in the circular ring section. An electrical voltage is thus in turn induced in the conductor tracks of the receiver coil 18, since the areas enclosed by the conductor tracks of the receiver coil 18 are located in parallel to the enclosed area of the conductor track of the emitter coil 17. The receiver coils 18 are thus inductively coupled to the emitter coil 17.

The coils 17, 18 and the magnetic field manipulator 10 are preferably arranged in relation to one another and dimensioned in such a way that an amplitude ratio between applied AC voltage and induced AC voltage in the receiver coil 18 is in a value range between −1 and +1, preferably between −0.3 and +0.3 in dependence on the pivot angle. The amplitude ratio of the AC voltage of the emitted coil 17 to the induced AC voltage of the receiver coil 18 thus varies as a function of the pivot angle α at least between −1 and +1, preferably between −0.3 and +0.3. It is also important that the magnetic field manipulator 10 and/or the conductor track of the receiver coil 18 are formed and arranged in such a way that the amplitude ratio between the AC voltage of the emitter coil 17 and the induced AC voltage of the receiver coil 18 is sinusoidal. To achieve this, as shown here on the basis of FIG. 4, the at least one conductor loop of the at least one receiver coil 18 is composed of sinusoidal and/or circular conductor track sections.

By comparison of the two AC voltages, in particular by demodulation of the induced AC voltage using the AC voltage of the emitter coil 17, an absolute value and a phase of the coupling are concluded. The absolute value varies in particular continuously with the pivot angle α, so that arbitrary pivot angles α can be acquired. The emitter coil 17 and the at least one receiver coil 18 are preferably configured in such a way that the phasing in relation to one another is 0° or 180°. The pivot angle α is concluded with the aid of the arctangent function, in particular in the case of three receiver coils 18, which preferably have a phase offset of 120°.

The receiver coil 18 preferably has at least one left-handed and at least one right-handed conductor track section in which, upon application of an external electromagnetic alternating field, oppositely oriented fields are always formed. In particular, each of the conductor tracks is pivoted in such a way that it is formed similarly to a figure-eight in the cross-sectional plane. Such a coil has the advantage that external interfering magnetic fields, in particular homogeneous external interfering magnetic fields, induce equal electrical interference voltages in opposing directions in each of both conductor track sections of the coil, i.e., in the right-handed section and in the left-handed section, so that the resulting overall electrical interference voltages are zero over the entire receiver coil and the acquisition of a pivot angle α using such a coil is not interfered with. The conductor tracks of the receiver coils 18 are thus arranged in such a way that the area enclosed in a region by a first conductor loop 20 of the respective receiver coil 18 is equal in size to the areas enclosed by one or more other conductor loops 21 of the same respective receiver coil 18, wherein the turn direction of the first conductor loop 20 is opposite to the turn direction of the one or more second conductor loops 21. For this purpose, the conductor tracks cross at least once. However, there is no electrical contact between the crossing conductor tracks in the crossing region 22. Such a first conductor loop 20 in the left half and a corresponding second conductor loop 21 in the right half are shown in FIG. 4 on the basis of the highlighted, dashed receiver coil 18, wherein both conductor loops 20, 21 are symmetrical to one another and thus enclose equal areas, but have an opposing turn direction. In such a receiver coil 18, electrical voltages are only induced in sections by homogeneous fields. However, the electrical voltage which can be acquired at the contact region 19 is zero. Such a coil is therefore not influenced by external homogeneous magnetic fields.

The magnetic field manipulator 10 (not shown in FIG. 4) covers a region of the printed circuit board 15 and thus a region of the receiver coil 18 and also a region of the emitter coil 17 in the coupled state of the coupling elements 5, 6. The respective adjacent regions are not covered by the magnetic field manipulator 10, but rather by the material surrounding the magnetic field manipulator 10, i.e., the coupling material here. Depending on the electrical and/or magnetic conductivity of the respective regions, an alternating magnetic field acting on the receiver coil 18 is either amplified or attenuated in this region. Because of this influence, i.e., the amplification or attenuation, of the receiver coils 18, an electrical voltage signal can be acquired in the contact region 19 of the receiver coils 18. A pivot angle α is ascertainable by means of this voltage signal and the analysis unit (not shown here), since the voltage signal is dependent on the pivot angle because of the circularity of the conductor track of the receiver coil 18. It is important that the magnetic field manipulator 10—in relation to the adjacent region, in particular in relation to the second coupling element 6—has a different electrical and/or magnetic conductivity. It is also important that the receiver coil 18 comprises various regions in which the turn direction is opposite in relation to one another. An angle measuring arrangement 23 is thus provided and is substantially independent of external homogeneous magnetic fields and can acquire, in particular can continuously acquire, a pivot angle α.

As is apparent from FIGS. 1 to 4, an angle measuring arrangement 23 is thus provided for acquiring a pivot angle α between the longitudinal center axis M1 of a tractor vehicle 2 and the longitudinal center axis M2 of a trailer 3 coupled to the tractor vehicle 2 by a coupling 4, which is in particular detachable and forms a pivot axis A in the vertex P of the pivot angle α, wherein the coupling 4 comprises a first coupling element connected to the tractor vehicle 2 and a second coupling element 6 connected to the trailer 3. In this case, a measured value generator 13 for generating a magnetic field and a measured value sensor 14 for acquiring the magnetic field are associated with the coupling 4. Moreover, an analysis unit (not shown in the figures) is for determining the pivot angle α in dependence on the magnetic field acquired by the measured value sensor 14.

Moreover, further electronic components of the angle measuring unit 23, such as application-specific integrated circuits (ASIC), microcontrollers, and/or further passive components are preferably arranged on the printed circuit board 15 and thus integrated into the coupling 4. The data interface to the tractor vehicle 2 and/or trailer 3 for transmitting the ascertained pivot angle α and preferably further data of the further electronic components is preferably provided by a serial bus system, particularly preferably by a CAN bus or another digital interface, particularly preferably SENT. Alternatively or additionally, an analog interface is provided.

A tractor vehicle 2 means an object leading in a travel direction of a tractor-trailer assembly 1 here and a trailer 3 means a following object. It is thus also possible to provide the angle-measuring assembly 23 described here between two motor vehicles, in particular for towing one of the motor vehicles, or between two trailers, in particular in tractor-trailer assemblies having multiple trailers. In the latter case, a first leading trailer functions as the tractor vehicle 2 and a second trailer following the first trailer functions as the trailer 3 in the meaning of this description.

1. An angle-measuring assembly for acquiring a pivot angle between a longitudinal center axis of a tractor vehicle and a longitudinal center axis of a trailer coupled to the tractor vehicle by a coupling, the coupling being detachable and forming a pivot axis in a vertex of the pivot angle, the coupling having a first coupling element connected to the tractor vehicle and a second coupling element connected to the trailer, the angle-measuring assembly comprising:
a measured value generator associated with the coupling and configured to generate a magnetic field, the measured value generator having an emitter coil;
a measured value sensor associated with the coupling and configured to sense the magnetic field, the measured value sensor having a receiver coil;
a magnetic field manipulator arranged on one of (i) the first coupling element and (ii) the second coupling element, the magnetic field manipulator being substantially axially opposite to the measured value generator and the measured value sensor in relation to the pivot axis; and
an analysis unit configured to determine the pivot angle based on the magnetic field sensed by the measured value sensor,
wherein the measured value generator and the measured value sensor are one of (i) both arranged on the first coupling element and (ii) both arranged on the second coupling element.

2. The angle-measuring assembly (23) as claimed in claim 1, wherein the magnetic field manipulator is one of arranged in, arranged on, formed in, and formed on one of (i) an eye of the second coupling element and (ii) a drawbar of the second coupling element.

3. The angle-measuring assembly as claimed in claim 1, wherein the magnetic field manipulator is formed by at least one recess in one of (i) the first coupling element and (ii) the second coupling element.

4. The angle-measuring assembly as claimed in claim 1, wherein the at least one recess that forms the magnetic field manipulator is filled up using an at least one of electrically and magnetically insulating material, the insulating material being at least one of an abrasion-resistant plastic a and an abrasion-resistant ceramic.

5. The angle-measuring assembly as claimed in claim 1, wherein at least one of (i) the measured value generator and (ii) the measured value sensor extends along a circumferential circle section in relation to the pivot axis.

6. The angle-measuring assembly as claimed in claim 5, wherein the circumferential circle section is one of a cylinder inner wall and a cylinder outer wall of one of the first coupling element and second coupling element.

7. The angle-measuring assembly as claimed in claim 5, wherein the circumferential circle section is one of a sphere inner wall and a sphere outer wall of one of the first coupling element and second coupling element.

8. The angle-measuring assembly as claimed in claim 1, wherein at least one of the measured value generator and the measured value sensor are covered by a protective layer.

9. The angle-measuring assembly as claimed in claim 1, wherein the measured value generator and the measured value sensor are arranged on the coupling such that the measured value sensor is inductively coupled to the measured value generator.

10. A coupling that detachably couples a trailer to a tractor vehicle and forms a pivot axis in a vertex of a pivot angle, the coupling comprising:
a first coupling element connected to a tractor vehicle;
a second coupling element connected to a trailer; and
an angle-measuring assembly configured to acquire the pivot angle between a longitudinal center axis of the tractor vehicle and a longitudinal center axis of the trailer, the angle-measuring assembly comprising:
a measured value generator associated with the coupling and configured to generate a magnetic field, the measured value generator having an emitter coil;
a measured value sensor associated with the coupling and configured to sense the magnetic field, the measured value sensor having a receiver coil;
a magnetic field manipulator arranged on one of (i) the first coupling element and (ii) the second coupling element, the magnetic field manipulator being substantially axially opposite to the measured value generator and the measured value sensor in relation to the pivot axis; and
an analysis unit configured to determine the pivot angle based on the magnetic field sensed by the measured value sensor,
wherein the measured value generator and the measured value sensor are one of (i) both arranged on the first coupling element and (ii) both arranged on the second coupling element.

11. The coupling as claimed in claim 10, wherein the coupling is configured as at least one of (i) a ball-hitch coupling, (ii) a pin-type coupling, and (iii) a fifth-wheel coupling.

12. The coupling as claimed in claim 10, wherein the coupling is a part of a tractor-trailer assembly having the tractor vehicle and the trailer coupled to the tractor vehicle.

13. A method for acquiring, using an angle-measuring assembly, a pivot angle between a longitudinal center axis of a tractor vehicle and a longitudinal center axis of a trailer coupled to the tractor vehicle by a coupling, the coupling being detachable and forming a pivot axis in a vertex of the pivot angle, the coupling having a first coupling element connected to the tractor vehicle and a second coupling element connected to the trailer, the angle-measuring assembly having (i) a measured value generator associated with the coupling and configured to generate a magnetic field, the measured value generator having an emitter coil, (ii) a measured value sensor associated with the coupling and configured to sense the magnetic field, the measured value sensor having a receiver coil, (iii) a magnetic field manipulator arranged on one of the first coupling element and the second coupling element, the magnetic field manipulator being substantially axially opposite to the measured value generator and the measured value sensor in relation to the pivot axis, and an analysis unit configured to determine the pivot angle based on the magnetic field sensed by the measured value sensor, wherein the measured value generator and the measured value sensor are one of (i) both arranged on the first coupling element and (ii) both arranged on the second coupling element, the method comprising:
generating a magnetic field using the measured value generator of the angle-measuring assembly;
acquiring the magnetic field using the magnetic field sensor of the angle-measuring assembly; and
determining the pivot angle using the analysis unit of the angle-measuring assembly, based on the acquired magnetic field influenced by the magnetic field manipulator.
